(19) United States
(12) Patent Application Publication
(10) Pub. No.: US 2008/0014551 A1
(43) Pub. Date: Jan. 17, 2008

(54) HANDPIECE FOR DENTAL OR SURGICAL USE

(75) Inventor: Alain Juan, Saint-Blaise (CH)

Correspondence Address: GRIFFIN & SZIPL, PC, SUITE PH-1, 2300 NINTH STREET, SOUTH, ARLINGTON, VA, 22204, US

(73) Assignee: Bien-Air Holding S.A., Bienne (CH)

(21) Appl. No.: 11/777,379

(22) Filed: Jul. 13, 2007

(30) Foreign Application Priority Data
Jul. 13, 2006 (EP) 06014540.6

(51) Int. Cl. A61C 3/00

(52) U.S. Cl. 433/114

(57) ABSTRACT

The present invention concerns a handpiece for dental or surgical use including a body via which the practitioner holds the instrument, characterized in that the body is made of a titanium-molybdenum alloy.

This application claims priority from European Patent Application No. 06014540.6 filed Jul. 13, 2006, the entire disclosure of which is incorporated herein by reference.

The present invention concerns a handpiece for dental or surgical use. More specifically, the present invention concerns an instrument for dental or surgical use whose body is made of a light material that can easily be machined.

There exist two main families of hand held instruments for dental or surgical use. The first of these families groups together what are known as turbines, i.e. instruments whose tool, for example a drill, is coupled to a motor driven by pressurized air. This type of motor can rotate at several hundreds of thousands of revolutions per minute with an air pressure typically of the order of 2.5 to 3 bars. The body of such a turbine via which the practitioner holds the instrument in his hand is conventionally connected to an electric power and fluid supply (air, water) unit via a connection and a flexible pipe. The second family of instruments for dental or surgical use groups together what are known as handpieces and contra-angle attachments. Handpieces and contra-angle attachments differ essentially in that the body of the handpiece is substantially straight whereas that of the contra-angle attachments forms an angle at one point along the length thereof. As regards the rest, these two types of instruments are very similar. A motor, secured to the handpiece or the contra-angle attachment and capable of rotating at several tens of thousands of revolutions per minute, is connected via a pipe with a fixed or rotating connection to the power supply unit.

For reasons of convenience, the instruments for dental or surgical use described above will be designated by the generic reference handpieces, in the knowledge that this expression covers both actual handpieces and turbines and contra-angle attachments.

The criticisms most frequently made by practitioners regarding the handpieces that they use daily in the practice of their profession concerns the resistance to wear and the weight of such instruments. Indeed, these handpieces are most often made of brass or stainless steel. Brass has the drawback of oxidising easily and thus has to undergo surface treatments with depositions of stainless materials. These layers, which are relatively fragile, tend to wear and be scratched easily, allowing the subjacent brass layer to appear in places, which gives practitioners the impression of an instrument of mediocre quality. As regards stainless steel, although this is a material appreciated by designers of handpieces for its qualities of machinability, hardness and resistance to corrosion, it has the drawback of being very heavy. Thus, a handpiece made of stainless steel will be heavy and thus tiring for the person who has to hold it in his hand for several hours a day.

Attempts have already been made to try to overcome these problems of resistance to wear and weight of handpieces for dental or surgical use. Thus, making the body of the handpieces of titanium has already been proposed. This material has the dual advantage of being resistant and light. This material is however difficult to machine since it has problems of auto flammability. Indeed, in order to make a handpiece from titanium, one starts with a bar made of this material which will then be pierced, milled, threaded etc. so that the body of the resulting handpiece meets the designer's requirements. It has been realised that, because of the high speeds at which the machining tools rotate, titanium tended to spontaneously ignite, which, as will easily be understood, is unacceptable in an industrial environment. In order to overcome this problem, it is possible to machine the titanium bar in an oxygen free environment, which is however restrictive and makes the operator's work even more difficult. Moreover, it has also been realised that when titanium is machined, it tends to form shavings which adhere to the machine tools. Thus, it is not rare to have to make several cuts in order to pierce a hole in a titanium bar, with the operator having to remove, between two successive cuts, the titanium shavings that have accumulated around the drilling tool. Finally, it has been observed that handpieces made of titanium have problems of an aesthetical nature, since the colour of titanium is very cold and unpleasant on the eye.

It is an object of the present invention to overcome the aforementioned drawbacks, in addition to others by providing an instrument for dental or surgical use which is both light and attractive.

The present invention therefore concerns a handpiece for dental or surgical use comprising a body via which the practitioner holds the instrument, characterized in that the body is made of a titanium-molybdenum alloy.

Owing to these features, the present invention provides an instrument for dental or surgical use which is made of a material that combines lightness, mechanical resistance and machinability. It has in fact been realised that the titanium-molybdenum alloy is much easier to machine than pure titanium. In particular, when drill holes, threading, bores or suchlike are made in a bar of titanium-molybdenum alloy, the material removed disintegrates in powder form rather than as shavings as is the case with a bar of pure titanium, which considerably simplifies machining operations. Above all, the titanium-molybdenum alloy does not ignite when it is machined using tools rotating at high speed, which makes it much safer to work with this material in an industrial environment.

The titanium-molybdenum alloy also has a high level of mechanical resistance while being extremely light, which substantially improves the comfort of use of a handpiece for dental or surgical use made in such material. Another determining advantage of the titanium-molybdenum alloy lies in the fact that it is highly resistant to corrosion. This proves a determining factor in the dental or surgical field where instruments are particularly stressed by the various cleaning, disinfecting and sterilising treatments. It has also been realised that handpieces made of titanium-molybdenum alloy have a very warm white colour that is attractive to the eye. There is thus no need to coat the titanium-molybdenum alloy with additional surface treatment layers, a simple mechanical treatment of the alloy surface, for example by micro-blasting, being sufficient to remove the machining lines and provide a remarkable surface state. This thus enables substantial savings to be made, but moreover avoids the problems linked with additional surface treatment layers which tend to wear quickly. Finally, it will be noted that titanium-molybdenum meets all requirements in terms of biocompatibility.

According to a complementary feature of the invention, the titanium-molybdenum alloy includes around 80% titanium by weight and the remaining weight is molybdenum.

It goes without saying that the present invention is not limited to the embodiment that has just been described and that various simple alterations and variants can be envisaged by those skilled in the art without departing from the scope of the invention as defined by the annexed claims.

What is claimed is:

1. A handpiece for dental or surgical use including a body via which the practitioner holds the instrument, wherein the body is made of a titanium-molybdenum alloy.

2. A handpiece according to claim 1, wherein the titanium-molybdenum alloy includes approximately 80% titanium by weight and the remaining weight in molybdenum.
